(19) United States
(12) Patent Application Publication
(10) Pub. No.: US 2002/0181861 A1
(43) Pub. Date: Dec. 5, 2002

(54) Optical fiber coupling assembly for optical detecting device

(75) Inventors: Robert E. Shroder, Windsor, CA (US); Lin Zhang, Plano, TX (US)

Correspondence Address: Gregory M. Taylor, WORKMAN NYDEGGER & SEELEY, P.O. BOX 45862, SALT LAKE CITY, UT, 84145, US

(73) Assignee: Optical Coating Laboratory, Inc.

(21) Appl. No.: 09/872,157

(22) Filed: Jun. 1, 2001

(51) Int. Cl. G02B 6/26

(52) U.S. Cl. 385/31; 385/39

(57) ABSTRACT

An optical fiber coupling assembly includes an optical fiber receiver, an optical spacer, and an optical filter such as a linear variable filter. The optical spacer can comprise either a monolithic block of optically transparent material, or an optical cavity within reflective walls. The fiber receiver can comprise either a machined attachment on an opaque lightweight block or can be a surface on the optical spacer configured to receive and adhesively bond an optical fiber. The optical spacer recirculates light that is incident on an optical filter segment that is not within the segment's designated wavelength range, thereby permitting multiple passes of the light within the assembly. A color measuring sensor device using the fiber coupling assembly can be incorporated with other components into a spectrometer device such as a portable calorimeter having a compact and rugged construction suitable for use in the field.

### BACKGROUND OF THE INVENTION

1. The Field of the Invention

The present invention is related to optical devices for measuring light. In particular, the present invention is related to an optical fiber coupling assembly for use in optical detecting devices.

2. The Relevant Technology

Optical devices known generally as spectrometers have been developed for measuring and analyzing the spectral or color content of electromagnetic radiation in the frequency range or spectrum of optical wavelengths. These include from ultraviolet, through visible, to near-infrared wavelengths, which include the portion of the electromagnetic spectrum producing photoelectric effects, referred to herein as “light.” Various kinds of opto-electronic devices are used for both imaging applications, such as by inspecting the spectral reflectance characteristics of a two-dimensional object, and for non-imaging applications.

Spectrometric measurements of light are performed in basically two ways, including dispersion-based techniques and filter-based techniques. In the dispersion-based approach, a radiation dispersion device such as a prism or diffraction grating is used to separate the incident polychromatic light into its spectral contents. The spectrally separated light is then projected onto a photodetector to measure the relative intensity in each spectral range. While dispersion-based devices can be effectively used in some applications, they have the disadvantage of being easily knocked out of alignment during use, and thus not suitable for more rigorous applications in the field.

In the filter-based approach to spectral measurement, various types of optical filters are used in conjunction with photodetectors to measure and analyze light. For example, in one approach, a single band-pass filter is placed over a detector to measure a single spectral band of the incident light. In another variation of the filter-based technique, a filter wheel on which several filters are mounted is used in conjunction with a single photodetector or several photodetectors. Alternatively, the discrete filters in the filter wheel can be replaced with a continuous circular variable filter (CVF), which is placed over a detector. Further, the CVF may be placed over several detectors to provide simultaneous spectra in a limited number of bands. These filter-based techniques are limited for practical reasons to use in low resolution spectral measurements of a few bands of light and to non-contiguous bands only.

Spectrometer devices have been developed that utilize linear variable filters in an attempt to enhance light measuring capabilities. For example, U.S. Pat. No. 5,166,755 to Gat (hereinafter “Gat”) discloses a spectrometer device including a spectrum resolving sensor containing an opto-electronic monolithic array of photosensitive elements which form a photodetector, and a continuous variable optical filter such as a linear variable filter (LVF) that is placed in an overlaying relationship with the photodetector. The LVF and the photodetector are mounted in a single housing which serves to support at least the filter and the photo detector array in a unitary sensor device. The LVF is formed by depositing optical coatings directly onto the photodetector array, or a preformed LVF may be positioned in contact with or slightly above the array.

However, Gat and other compact LVF spectrometers have the need to be fully illuminated across the entire filter surface. This results in very low system throughput since most of the incident energy at a specific wavelength is reflected from the LVF surface, being outside the transmissive segment of an LVF segment at that wavelength. Further, for many spectroscopic applications, the requirement that the coated plane surface be fully illuminated is a disadvantage because the light source or reflecting surface may not encompass an area large enough to provide full illumination.

Current compact spectrometers also lack an optical system to aid in reducing the numerical aperture of the light incident on the detector array. As a result, they allow light from a broad or diffuse source to propagate to the detector array at high incident angle, thus striking the detector array at locations removed from the actual LVF bandpass location. This reduces the resolution and increases the stray light characteristic of the device.

Accordingly, there is a need for an optical detector device that overcomes or avoids the above problems and limitations.

### SUMMARY AND OBJECTS OF THE INVENTION

It is an object of the invention to provide a lower cost, more compact spectrometer device.

It is another object of the invention to provide a low numerical aperture beam of light upon the entire surface of a linear variable filter in a spectrometer device.

It is a further object of the invention to provide a connecting port to mate a compact spectrometer device to a standard fiber optic cable device.

It is yet another object of the invention to increase the overall system efficiency of a compact spectrometer device.

In order to achieve the forgoing objects and in accordance with the invention as embodied and broadly described herein, fiber coupling assemblies are provided that include structures for receiving an optical fiber, an optical filter, a reflective surface, and an optical spacer, wherein the optical spacer is disposed between the optical filter and the reflective surface. Light that is incident upon a segment of the optical filter that is outside the passband for that segment is reflected, and the reflected light is recirculated by the reflective surface and the optical spacer so that the light is repeatedly incident upon the optical filter.

In various embodiments of the invention, the optical spacer can be a monolithic block of glass, or other optically transparent material. Alternatively, the spacer can comprise an optical cavity, defined by reflective walls and a filter surface. The structure for receiving an optical fiber can be a fiber receiving member of the optical spacer, or a separate fiber receiving block that is machined to include a fiber ferrule and optionally other features to securely receive an optical fiber.

In one embodiment of the invention, a color measuring sensor device for a spectrometer device is provided. This embodiment includes a fiber coupling means for securely receiving an optical fiber, a filter means for selectively transmitting light received from the fiber coupling means in a linearly variable manner along a length thereof, a light circulating means for repeatedly reflecting light received from the optical fiber onto the filter means, a detector means for measuring the spectral characteristics of the light transmitted through the filter means, the detector means having a photosensitive surface positioned directly opposite from the filter means a predetermined distance, and a light propagating means for transmitting light from the filter means to the detector means and projecting an upright, noninverted image of the filter means onto the photosensitive surface of the detector means.

Another aspect of the invention comprises a method of fully illuminating a linear variable filter. The method comprises directing a beam of light into an optical cavity, wherein the optical cavity has a first side and a second side, the first side having a reflective coating thereupon, the second side being adjacent to a linear variable filter, repeatedly reflecting light that is incident upon the reflective coating towards the linear variable filter, repeatedly reflecting light that is incident upon a segment of the linear variable filter that is not in the preselected passband for that segment of the linear variable filter, and transmitting light incident upon a portion of the linear variable filter that is in the preselected passband for that segment of the linear variable filter.

These and other objects and features of the present invention will become more fully apparent from the following description and appended claims, or may be learned by the practice of the invention as set forth hereinafter.

### BRIEF DESCRIPTION OF THE DRAWINGS

In order to illustrate the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic depiction of a fiber coupling assembly according to one embodiment of the present invention;

FIG. 2 is a schematic depiction of a fiber coupling assembly according to another embodiment of the present invention;

FIG. 3 is a schematic depiction of a fiber coupling assembly according to yet another embodiment of the present invention;

FIG. 4 is a schematic depiction of a fiber coupling assembly according to still another embodiment of the present invention;

FIG. 5 is a schematic depiction of a color measuring sensor device according to one embodiment of the present invention; and

FIG. 6 is a schematic depiction of a color measuring sensor device according to another embodiment of the present invention.

### DETAILED DESCRIPTION OF THE INVENTION

The present invention is directed to fiber coupling assemblies for an optical filter used in light measuring devices such as spectrometers. The fiber coupling assemblies allow the light emitted from an optical fiber to fully illuminate a planar optical surface to which an optical filter, such as a linear variable filter (“LVF”) has been applied in the form of a thin film coating. The fiber assembly coupling circulates the light reflected from the optical filter or a reflective surface in an optical spacer, permitting multiple passes of the light inside the optical spacer. The light is, therefore, repeatedly incident on the optical filter, thus increasing the probability of its transmission through the optical filter and the overall efficiency of a device containing the optical filter. A connecting port for an optical fiber is also provided to permit mating of the optical fiber to the fiber coupling assembly.

A preferred use for the fiber coupling assembly is in a color measuring sensor device such as a spectrometer that is compact and rugged. A complete color measuring sensor device generally includes a connecting port for an optical fiber, an optical spacer, an optical filter, an optical detector array, and light propagating means for transmitting light which is disposed between the optical filter and the optical detector array.

Referring to the drawings, wherein like structures are provided with like reference designations, the drawings only show the structures necessary to understand the present invention. Additional structures known in the art have not been included to maintain the clarity of the drawings.

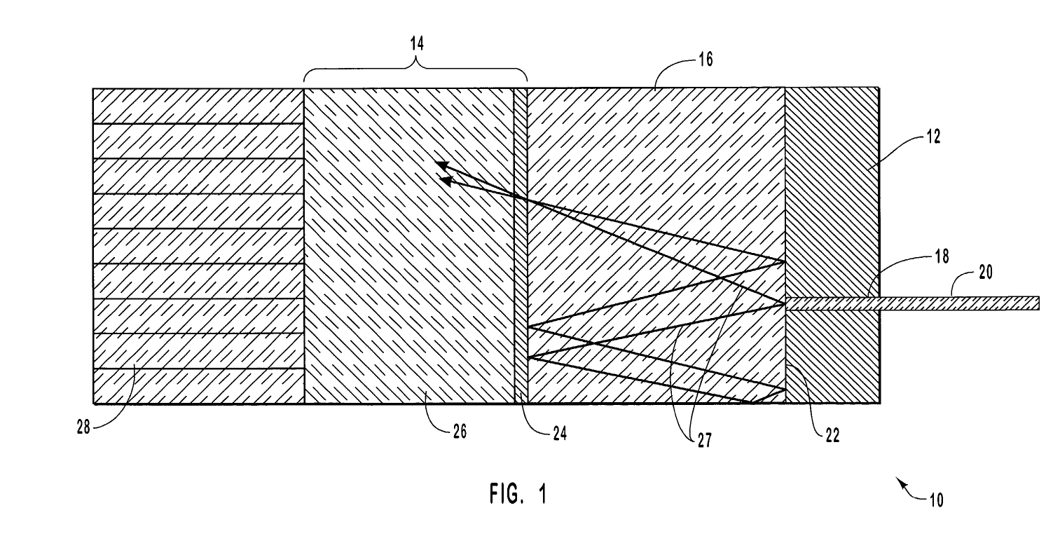

FIG. 1 is a schematic depiction of an optical fiber coupling assembly 10 according to one embodiment of the present invention. The assembly 10 generally includes a fiber receiving block 12 for receiving an optical fiber, a filter means for selectively transmitting light in a linearly variable manner such as an optical filter 14, and an optical spacer 16 for circulating light reflected between fiber receiving block 12 and optical filter 14. The optical spacer 16 is positioned between fiber receiving block 12 and optical filter 14, with the interface between optical spacer 16 and fiber receiving block 12 forming a substantially planar optical surface that is preferably substantially parallel with the interface between optical spacer 16 and optical filter 14, which is also a substantially planar optical surface. Each of the above elements of assembly 10 can be attached one to another by use of an optical adhesive. The various components of assembly 10 will be discussed in further detail below.

The fiber receiving block 12 includes a bore drilled or inserted therethrough, with the bore defining a fiber ferrule 18. Accordingly, an optical fiber 20 is coupled to assembly 10 by inserting a terminal end of optical fiber 20 into the fiber ferrule 18 of fiber receiving block 12. Although the fiber ferrule 18 is sized to receive optical fiber 20, the fiber itself can be bonded into the fiber ferrule using techniques similar to those used to bond fiber into the various types of ferrules used in standard fiber connectors. The fiber ferrule 18 can be designed to receive a stripped end of an optical fiber, a non-stripped end of an optical fiber, or a fiber bundle.

The fiber receiving block 12 preferably has a polished surface 22 so that light incident thereupon is reflected. The polished surface 22 is positioned substantially parallel to optical filter 14 so that light incident on the polished surface reflects light back to the optical filter surface.

The fiber receiving block 12 can be formed of an opaque lightweight material such as aluminum. Aluminum is preferable because it forms a reflective surface when polished. Nevertheless, other suitable materials for fiber receiving block 12 include stainless steel, brass, nickel-plated aluminum, or glass.

The optical spacer 16 is optically transparent over the spectral range of interest, and is preferably formed of glass or plastic materials. The optical spacer 16 is preferably a rectangular block with six sides, referred to for convenience as the top side, the bottom side, and four lateral sides. The optical spacer 16 is polished on all sides to ensure that a maximum reflectivity is maintained within the optical spacer with minimum beam attenuation. Preferably, a total internal reflection is achieved on each lateral side of the optical spacer. This is maintained by the near normal path of light within the optical spacer.

The optical fiber 20 preferably has a numerical aperture less than about 0.7. This is because a fiber with a numerical aperture less than about 0.7 emits light into the glass spacer that should totally internally reflect from all side surfaces and remain contained within the spacer except for absorption losses on the coatings or transmission through the optical filter.

Adjacent to optical spacer 16, fiber coupling assembly 10 further comprises a filter means for selectively transmitting light in a linearly variable manner, such as an optical filter 14. As illustrated in FIG. 1, a preferred filter means comprises a thin film coating 24 on a transparent substrate 26 that supports coating 24. The surface of the thin film coating defines a substantially planar optical surface. Preferably, optical filter 14 is an LVF that is constructed to selectively transmit light in a linearly variable manner along the length thereof. For example, a substrate 26 can be covered with a film in such a manner as to form a variable thickness coating having a substantially wedge-shaped profile across the length of the long dimension of the substrate. The LVF is typically made of stacked layers of all dielectric materials using hard, durable oxides, but may also be made of stacked layers of metal/dielectric materials such as silver and low index dielectrics. The thickness of the layers in the LVF is controlled during manufacture to create a filter with differing center wavelengths across the length thereof. This results in light being separated into its spectral colors along the length of the filter, e.g., from red light at one end to blue light at the other.

The substrate 26 of the LVF is preferably formed to have a relatively rectangular shape and is made of a material which is selected on the basis of the desired range of wavelengths in which the filter operates. Suitable materials for substrate 26 include fused silica, glass, and the like.

In the embodiment of FIG. 1, the LVF coated surface faces outward toward the optical spacer and receiving block 12. This creates a space in which light 27 emitted from the fiber may reflect many times between thin film coating 24 and polished surface 22 of fiber receiving block 12. The thin film coating, combined with polished surface 22 and the total internal reflection on the lateral sides of optical spacer 16 effectively closes the space so that no light may escape except through absorption losses in the coatings or by transmission through the LVF. This arrangement increases the likelihood of the light being transmitted through the LVF and propagating into a spectrometer device utilizing fiber coupling assembly 10.

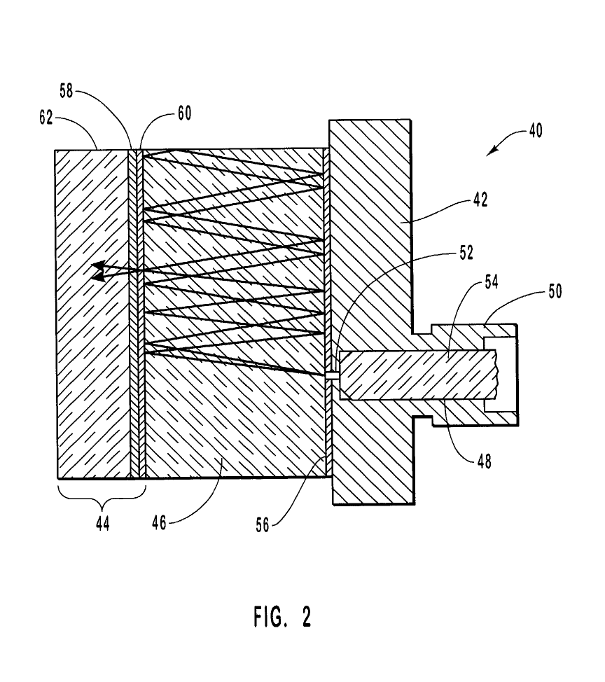

To further illustrate the utility of the invention, a light propagating means for transmitting light (or light transmitting means) is shown in FIG. 1 adjacent to and in optical communication with optical filter 14. As illustrated in FIG. 1, the light transmitting means is provided in the form of a lens array 28 such as a set of gradient index (GRIN) lenses. The lenses 28 are configured with respect to optical filter 14 such that light beams propagating through the lenses from optical filter 14 project an upright, noninverted image of optical filter 14 onto the photosensitive surface of a detector array (not shown). Other suitable light transmitting means may comprise a plurality of microlenses or a coherent fiber faceplate. Both the GRIN lens and the microlens embodiments are further described in U.S. Pat. No. 6,057,925 to Anthon (hereinafter the “Anthon patent”), the disclosure of which is incorporated herein by reference. Of course, one skilled in the art will recognize, in light of the disclosure herein, that other light transmitting means are also possible and are encompassedReferring now to FIG. 2, an optical fiber coupling assembly 40 according to another embodiment of the invention is shown. The fiber coupling assembly 40 generally includes a fiber receiving block 42 for receiving an optical fiber 54, an optical filter 44 for selectively transmitting light in a linearly variable manner, and an optical spacer 46 for circulating light reflected between fiber receiving block 42 and optical filter 44. The optical spacer 46 is positioned between fiber receiving block 42 and optical filter 44, with the interface between optical spacer 46 and fiber receiving block 42 being substantially parallel with the interface between optical spacer 46 and optical filter 44. Each of the above elements of assembly 40 will be discussed in further detail below.

As with the embodiment of FIG. 1, fiber receiving block 42 includes a bore drilled or inserted therethrough, the bore defining a fiber ferrule 48 that extends partially through fiber receiving block 42. In addition to fiber ferrule 48, however, fiber receiving block 42 also includes a connector 50 and a microchannel 52. The connector 50 is configured to provide a standard fiber optic cable receptacle to facilitate fiber connections. One skilled in the art will recognize, in light of the disclosure herein, that a variety of fiber connector types can be incorporated into a connector 50. These include, by way of example only, SMA, ST, FC, and SC connectors. Accordingly, optical fiber 54 is coupled to assembly 40 by mating a standard optical fiber connector attached to optical fiber 54 with connector 50 of fiber receiving block 42.

The microchannel 52 is preferably radially centered and linearly arranged with fiber ferrule 48 such that the fiber ferrule and the microchannel together form a conduit through fiber receiving block 42. The microchannel 52 allows light to propagate from fiber 54 into optical spacer 46 while minimizing the light lost back through the microchannel. This feature improves the efficiency of the assembly.

Suitable materials for fiber receiving block 42 are as described hereinabove for fiber receiving block 12. Connector 50 can be machined as a monolithic portion of fiber receiving block 42, or can be attached as a separate member, to meet the requirements for a standard optical fiber connector.

Although fiber receiving block 42 may be polished on one surface as described hereinabove for surface 22, fiber receiving block 42 can include a thin film reflective coating 56 having high reflectivity in the spectral region of interest disposed on one surface. The reflective coating 56 provides greater reflectivity than a polished surface. The reflective coating 56 can be formed, for example, of a metallic reflector by depositing an opaque metallic layer such as aluminum. Another preferred reflective coating is an all-dielectric reflector. Typically, dielectric reflectors are more durable than metallic reflectors, but are limited in terms of bandwidth and are more sensitive to incidence angle. The reflective coating also may be deposited upon a substrate or multiple substrates and subsequently affixed to the desired surface in an optically continuous manner. Numerous other possible reflective materials, as well as their optimal thicknesses and methods of deposition are well known to those skilled in the optical arts and are encompassed by this invention. Optionally, the reflective coating can be formed on optical spacer 46 rather than fiber receiving block 42.

The optical spacer 46 is formed substantially as described hereinabove for optical spacer 16. Thus, optical spacer 46 is optically transparent over the spectral range of interest.

Adjacent to optical spacer 46, fiber coupling assembly 40 further comprises a filter means for selectively transmitting light in a linearly variable manner, such as optical filter 44. As with optical filter 14, optical filter 44 comprises a thin film coating 58 on a transparent substrate 62 that supports thin film coating 58, with the surface of the thin film coating defining a substantially planar optical surface. Preferably, thin film coating 58 is an LVF coating which is constructed to selectively transmit light in a linearly variable manner along the length thereof, as described hereinabove. However, in this embodiment optical filter 44 also comprises thin film 60. Thin film 60 is a blocking filter that excludes certain wavelength ranges from contacting the LVF coating. The thin film 60 is an optional layer in each of the embodiments described herein and increases the efficiency of the LVF while reducing the blocking requirements of the LVF coating. The substrate 62 of optical filter 44 is formed substantially as described hereinabove for substrate 26.

In the embodiment of FIG. 2, thin film coating 58 (and the blocking filter formed by thin film 60) faces toward optical spacer 46 and fiber receiving block 42. This creates a space in which light emitted from fiber 54 may reflect many times between thin film coating 58 and reflective coating 56 on fiber receiving block 42. The thin film coating 58, combined with reflective coating 56 and the total internal reflection on the lateral surfaces of optical spacer 46 effectively closes the space so that no light may escape except through absorption losses in the coatings or by transmission through the blocking filter and the LVF. This arrangement increases the likelihood of the light being transmitted through the LVF and propagating into a spectrometer device utilizing fiber coupling assembly 40.

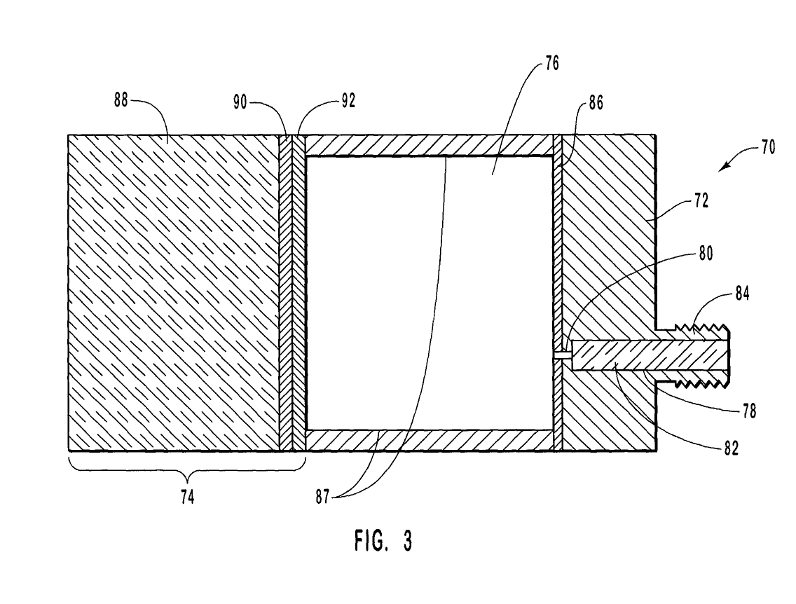

Referring now to FIG. 3, an optical fiber coupling assembly 70 according to yet another embodiment is shown. The assembly 70 generally includes a fiber receiving block 72 for receiving an optical fiber, an optical filter 74 for selectively transmitting light in a linearly variable manner, and an optical cavity 76 for containing light reflected between fiber receiving block 72 and optical filter 74. The optical cavity 76 is positioned between fiber receiving block 72 and optical filter 74, with the interface between optical cavity 76 and fiber receiving block 72 being substantially parallel with the interface between optical cavity 76 and optical 74. Each of the above elements of device 70 will be discussed in further detail hereinafter below.

Similar to the fiber receiving blocks discussed hereinabove, fiber receiving block 72 includes a bore drilled or inserted therethrough, the bore defining a fiber ferrule 78; a microchannel 80 to permit light to pass through fiber receiving block 72 while minimizing any light that may pass back through; and a connector 84 for receiving optical fiber 82. As illustrated in FIG. 3, fiber receiving block 72 is fabricated to present a standard interface to an SMA type fiber connector. Thus, connector 84 can be a threaded male connector that screws onto a threaded interface. Of course, other known connectors, including those discussed hereinabove, could also be used as connectors in this embodiment.

Suitable materials for fiber receiving block 72 are as described hereinabove for fiber receiving block 12. The surface of fiber receiving block 72 that faces the optical cavity preferably includes a thin film reflective coating 86 having high reflectivity in the spectral region of interest, although a simple polished surface may suffice for some applications. The reflective coating 86 can be formed of the same materials described hereinabove for reflective coating 56.

In contrast to the previous embodiments, however, optical cavity 76 comprises a rectangular cavity that is enclosed by reflective coating 86 on one side, a set of opposing reflective walls 87 on four lateral sides, and optical filter 74 on the sixth side. Light transmitting through and reflecting within optical cavity 76 transmits through air or an inert gas environment within optical cavity 76.

The lateral reflective walls 87 may be formed of molded plastic with silver or gold coatings. Other suitable materials and coatings include those described hereinabove for fiber receiving block 12 and for reflective coating 56. The high angle of incidence of light within optical cavity 76 on the reflective walls generally relax as the requirements for the reflectivity of these coatings. In fact, because of the high angle of incidence, light typically totally internally reflects inside the optical cavity off the reflective walls to fully contain the light emitted from the optical fiber.

As illustrated, optical filter 74 comprises a substrate 88 with an LVF coating 90. Optionally, a blocking filter coating 92 is applied thereover. Suitable materials and structures for optical filter 74 and blocking filter coating 92 are the same as described hereinabove for the corresponding components of assembly 40 of FIG. 2.

In the embodiment of FIG. 3, LVF coating 90 (and blocking filter coating 92) faces toward optical cavity 76 and fiber receiving block 72. The optical cavity, lined laterally with the four reflective walls, LVF coating 90 (and blocking filter coating 92), and reflective coating 86, defines a space in which light emitted from an optical fiber may reflect many times therein. The LVF coating 90, combined with reflective coating 86 and the total internal reflection on the lateral reflective walls effectively closes the cavity so that no light may escape except through absorption losses in the coatings or by transmission through the blocking filter and the LVF. This arrangement increases the likelihood of the light being transmitted through the LVF and propagating into a spectrometer device utilizing fiber coupling assembly 70.

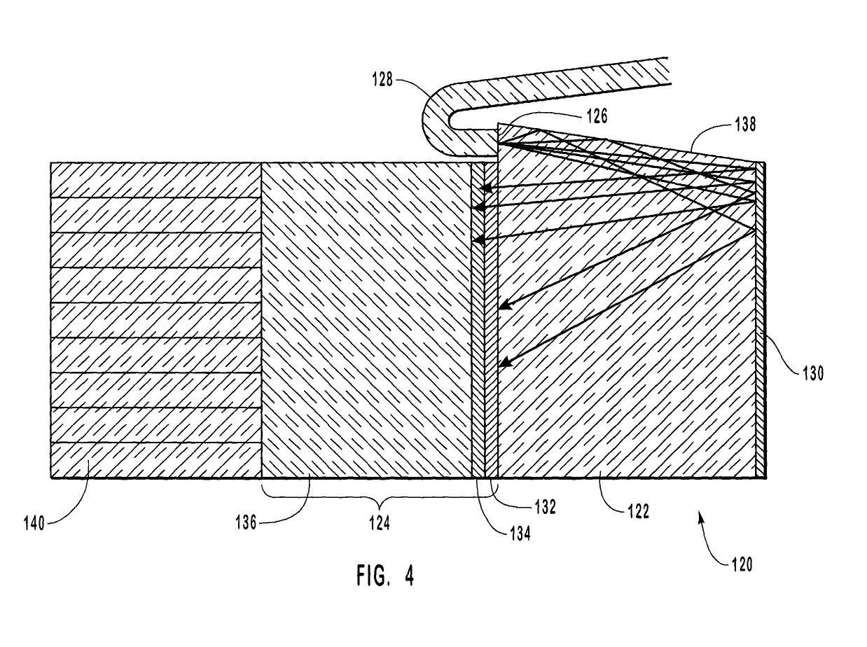

FIG. 4 illustrates another embodiment of the invention in the form of an optical fiber coupling assembly 120. In this embodiment, the fiber receiving block is omitted. Therefore, fiber coupling assembly 120 generally includes a filter means 124 for selectively transmitting light in a linearly variable manner such as an optical filter 124, a wedge shaped optical spacer 122 for circulating light and allowing light to be repeatedly directed onto the surface of optical filter 124, and a reflective coating 130 applied on a surface of optical spacer 122 that is opposite optical filter means 124. The optical spacer 122 further includes a fiber coupling portion 126 for attachment of an optical fiber 128. Each of the above elements of assembly 120 will be discussed in further detail below.

As indicated, the fiber receiving block is not required in this embodiment. In order to attach an optical fiber, optical spacer 122 is configured with fiber coupling portion 126 that extends laterally from one side of optical spacer 122. The optical fiber 128, preferably having a low numerical aperture, is bonded directly to the laterally extending surface of coupling portion 126. A further improvement may be realized by adding a GRIN lens collimator or a tapered profile to the end of optical fiber 128 that is attached to fiber coupling portion 126. This reduces the numerical aperture of the light input to the optical spacer 122, thus reducing scattering or reflective losses at the internal surfaces of the wedged spacer.

The reflective coating 130 on optical spacer 122 can be formed of any of the reflective coating materials as described hereinabove, and is preferably formed with high efficiency broadband reflective coating materials. The reflective coating 130 can be applied directly as one or more coating layers upon optical spacer 122, or can be applied to a separate substrate that is subsequently affixed to optical spacer 122.

The optical spacer 122 thus has a reflective coating 130 on one surface, with optical filter 24 facing an opposing surface. Both of these opposing surfaces define substantially planar optical surfaces. Three of the lateral surfaces of optical spacer 122 are perpendicular to the optical surfaces so that any light incident upon the lateral surfaces is at a high angle and the light thus totally internally reflects. The fourth lateral surface of optical spacer 122 is a sloped surface 138 which provides the wedge shape to optical spacer 122. All of the lateral surfaces are preferably polished and more preferably have a reflective coating thereon so that light will totally internally reflect from all internal surfaces of optical spacer 122 at high angles of incidence. The light incident thru optical fiber 128 is totally internally reflected from sloped surface 138 of optical spacer 122. The early normal angle of sloped surface 138 ensures that the incident angle of the light is close to normal with the filter surface. The small angle of incidence ensures there is virtually no loss of resolution of the system due to diffuse illumination of the filter surface.

As with the previous embodiments, optical spacer 122 can be formed either of a monolithic piece of glass or plastic, or can be formed as an optical cavity. Preferred structures and materials are substantially as described hereinabove. However, if an optical cavity is employed, reflective coating 130 comprises a separate member that is either an opaque reflector polished on one side or a reflective layer applied to an underlying substrate.

As illustrated, optical filter 124 comprises a transparent substrate 136 with an LVF coating 134 thereon, and optionally a blocking filter coating 132 applied thereover. Suitable materials and structures for these filter coatings are as described hereinabove.

To further illustrate the utility of the invention, a light transmitting means in the form of a set of a lens array 140, such as a set of GRIN lenses, is shown adjacent to and in optical communication with optical filter 124. Other suitable structures for the light transmitting means are as described hereinabove for the embodiment of FIG. 1. Of course, one skilled in the art will recognize, in light of the disclosure herein, that light transmitting means can optionally be included with each of the embodiments of the invention.

In the embodiment of FIG. 4, LVF coating 134 (and blocking filter coating 132) face toward optical spacer 122. The optical spacer 122 creates a space in which light emitted from optical fiber 128 may reflect many times between optical filter 124 and reflective coating 130. The optical filter surface, combined with reflective coating 130 and the total internal reflection on the lateral sides of optical spacer 122 effectively closes the space so that no light may escape except through absorption losses in the coatings or by transmission through the blocking filter and the LVF. This arrangement increases the likelihood of the light being transmitted through the LVF coating and propagating into further elements of a spectrometer device utilizing fiber coupling assembly 120.

The fiber receiving and light circulating assemblies of the invention can be provided to instrument manufacturers as separate parts for use in a variety of color analyzing photometric instruments. The assemblies can also be directly incorporated into spectrometer devices such as a colorimeter during a single manufacturing process. For example, a fiber coupling assembly of the invention can be incorporated with other components into a portable, compact colorimeter such as a hand-held device for color measurement.

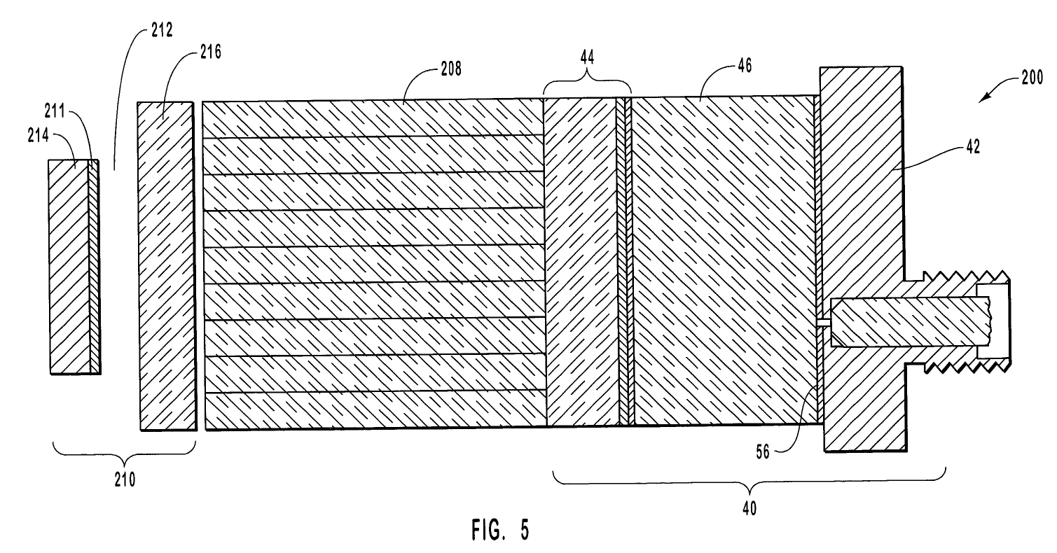

Referring now to FIG. 5, a color measuring sensor device 200 is illustrated that incorporates the fiber coupling assembly of FIG. 2 according to one embodiment of the invention. The sensor device 200 can be employed in a compact spectrometer device such as in the Anthon patent, previously incorporated by reference. The sensor device 200 generally includes a filter coupling assembly 40 with substantially the same components as described for the embodiment of FIG. 2, including fiber receiving block 42, an optical filter 44, a reflective coating 56, and an optical spacer 46. The sensor device 200 further includes a light transmitting means such as a lens array 208, and an optical detector array 210.

The fiber receiving block 42, optical filter 44, reflective coating 56, and optical spacer 46 are substantially as disclosed hereinabove for the embodiment of FIG. 2. The lens array 208 can be a series of gradient index lenses or microlenses.

The optical detector array 210 is employed to measure the spectral characteristics of the light transmitted through optical filter 44. The detector array 210 is positioned directly opposite from optical filter 44 a predetermined distance, with lens array 208 disposed between optical filter 44 and detector array 210 in at least one row. The detector array 210 includes an image chip 211 such as a photodiode array that is supported on a substrate 214 made of a semiconductor material. The image chip 211 has a photosensitive surface positioned directly opposite from optical filter 44 a predetermined distance. The photodiode array of image chip 211 is formed of a series of silicon detectors with sensor sites or pixels that can be addressed individually. A transparent cover 216 is typically positioned a short distance from image chip 211 so that a gap 212 is formed between image chip 211 and cover 216.

The optical detector array 210 can be selected from a variety of linear detector array devices that are commercially available, including parallel output type devices or various charge storage or transfer devices which are customarily referred to as charge coupled devices (CCD), charge injection devices (CID), charge coupled photo diode arrays (CCPD), and the like. These devices include a monolithic or hybrid integrated circuit which contains the electronics for sequential scanning and reading the signal of each pixel in the detector array, and are manufactured utilizing large scale integration (LSI) technology.

Although not shown, it should be understood by those skilled in the art, in view of the disclosure herein, that the other embodiments of the fiber coupling assembly of the invention shown in FIGS. 1, 3, and 4 could also be employed in sensor device 200 in place of fiber coupling assembly 40.

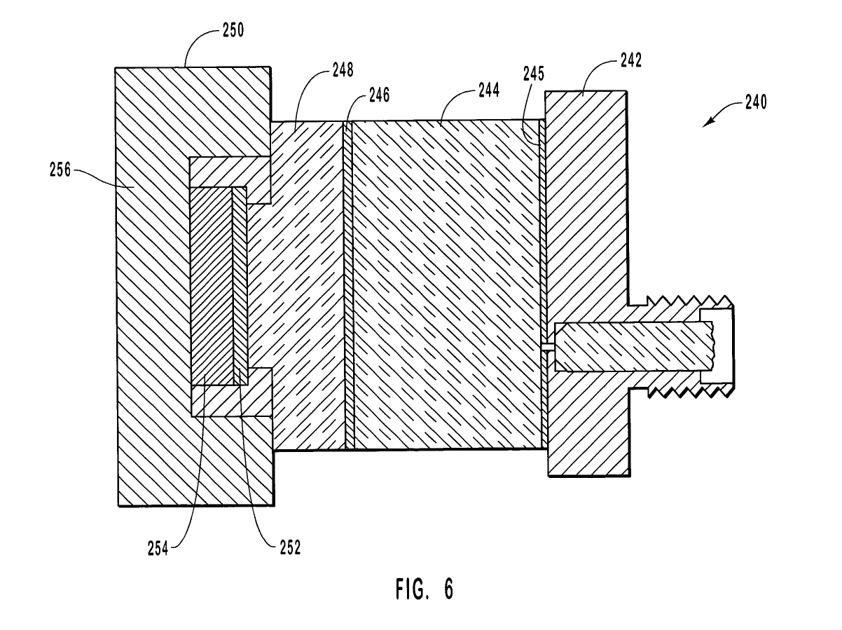

FIG. 6 illustrates another color measuring sensor device 240 that can be utilized in a compact spectrometer device that incorporates a fiber coupling assembly according to the present invention. This embodiment incorporates elements of the sensor device disclosed in commonly assigned and copending U.S. patent application Ser. No. 09/846,897 filed on May 1, 2001, the disclosure of which is incorporated herein by reference. Accordingly, sensor device 240 generally includes a fiber receiving block 242, an optical spacer 244, reflective coating 245 a thin film filter coating 246, a coherent fiber face plate 248, and an optical detector array 250.

In this embodiment, thin film coating 246 (such as an LVF) is applied to optical spacer 244 rather than a separate substrate. This allows filter coating 246 to be adjacent to fiber face plate 248 and improve the resolution of the device. The fiber face plate 248 transmits light received from filter coating 246 and projects an upright, noninverted image of the filter onto the photosensitive surface 252 of detector array 250. The photosensitive surface 252 is applied to a substrate 254, and both are housed within a housing 256 of suitable material. The sensor device 240 provides for an efficient and reliable spectrometer device that is compact and durable.

A spectrometer device such as a colorimeter formed according to the present invention has, in general, four major subsystems or modules. These include: an optical module which includes the fiber receiving and light circulating assembly discussed above, a detector circuit module, a signal processing module, and an output module. A further description of the above modules is provided in the Anthon patent, and is encompassed by the present invention.

The fiber coupling assembly of the present invention incorporated into a spectrometer device can be used in many different applications that require color discrimination or evaluation. For example, compact spectrometers using the assembly of the invention can be utilized for general color discrimination such as in identifying objects or merchandise by color, and can be used for color matching of paints, inks, dyes, fabrics, paper, or a variety of other objects. Further, spectrometer devices utilizing the assembly of the invention can be employed in various medical applications such as medical diagnostics. For example, such devices can be employed in the detection of changes in skin color or body fluid color that are not visible to the eye, and can also be used in medical color evaluation. Such spectrometer devices can also be utilized in various agricultural applications, and in process controls.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. An optical fiber coupling assembly, comprising:
an optical fiber receiving structure;
an optical filter; and
an optical spacer interposed between the fiber receiving structure and the optical filter;
wherein light incident upon a region of the optical filter that is outside the passband for that region is recirculated within the optical spacer so that the light is repeatedly incident upon the optical filter.

2. The assembly of claim 1, wherein the optical spacer comprises a monolithic block of transparent material.

3. The assembly of claim 1, wherein the optical spacer comprises a plurality of reflective walls that define an optical cavity.

4. The assembly of claim 1, wherein the fiber receiving structure comprises a fiber receiving block with a fiber ferrule therein.

5. The assembly of claim 4, wherein the fiber ferrule extends partially through the fiber receiving block, the assembly further comprising a microchannel that is radially centered and linearly arranged with the fiber ferrule such that the fiber ferrule and the microchannel together form a conduit through the fiber receiving block.

6. The assembly of claim 4, further comprising a fiber connector surrounding a portion of the fiber ferrule.

7. The assembly of claim 1, wherein the optical filter comprises a linear variable filter.

8. The assembly of claim 1, wherein the optical filter comprises a linearly variable thin film coating applied on the surface of a substrate.

9. The assembly of claim 8, further comprising a blocking filter coating over the linearly variable thin film coating.

10. An optical fiber coupling assembly for an optical detecting device, the assembly comprising:
an optical fiber receiving structure;
an optical spacer including a plurality of walls that define an optical cavity;
a reflective surface on one side of the optical cavity; and
an optical filter defining a surface of the optical cavity opposite from the reflective surface;
wherein light incident upon a region of the optical filter that is outside the passband for that region is recirculated within the optical spacer so that the light is repeatedly incident upon the optical filter.

11. The assembly of claim 10, wherein the fiber receiving structure comprises a fiber receiving block with a fiber ferrule therein.

12. The assembly of claim 11, wherein the fiber ferrule extends partially through the fiber receiving block, the assembly further comprising a microchannel that is radially centered and linearly arranged with the fiber ferrule such that the fiber ferrule and the microchannel together form a conduit through the fiber receiving block.

13. The assembly of claim 1, further comprising a fiber connector surrounding a portion of the fiber ferrule.

14. The assembly of claim 10, wherein the optical filter comprises a linear variable filter.

15. The assembly of claim 10, wherein the optical filter comprises a linearly variable thin film coating applied on the surface of a substrate.

16. The assembly of claim 15, further comprising a blocking filter coating over the linearly variable thin film coating.

17. The assembly of claim 10, wherein the optical cavity is defined by a surface of the optical filter, the reflective surface, and four lateral surfaces.

18. An optical fiber coupling assembly for an optical detecting device, the assembly comprising:
a fiber receiving block having a fiber ferrule configured to receive an optical fiber;
a monolithic optical spacer;
a reflective surface adjacent to the optical spacer; and
an optical filter for selectively transmitting light in a predetermined range of wavelengths along a length thereof, the optical filter adjacent to the optical spacer and opposite from the reflective surface;
wherein light incident upon a region of the optical filter that is outside the passband for that region is recirculated within the optical spacer so that the light is repeatedly incident upon the optical filter.

19. The assembly of claim 18, wherein the reflective surface comprises a polished surface of the fiber receiving block.

20. The assembly of claim 18, wherein the reflective surface comprises a reflective coating applied to the fiber receiving block or the optical spacer.

21. The assembly of claim 18, wherein the optical spacer is composed of glass.

22. The assembly of claim 18, wherein the fiber ferrule extends partially through the fiber receiving block, the assembly further comprising a microchannel that is radially centered and linearly arranged with the fiber ferrule such that the fiber ferrule and the microchannel together form a conduit through the fiber receiving block.

23. The assembly of claim 18, further comprising a fiber connector surrounding a portion of the fiber ferrule.

24. The assembly of claim 18, wherein the optical filter comprises a linearly variable thin film coating applied on the surface of a substrate.

25. The assembly of claim 24, further comprising a blocking filter coating over the linearly variable thin film coating.

26. An optical fiber coupling assembly for an optical detecting device, the assembly comprising:
an optical spacer having a first side and an opposing second side, the first side having a reflective coating thereon and the second side having an optical fiber coupling portion; and
an optical filter facing the second side of the optical spacer, the optical filter including a linear variable filter coating adjacent to the second side of the optical spacer;
wherein light incident upon a region of the optical filter that is outside the passband for that region is recirculated within the optical spacer so that the light is repeatedly incident upon the optical filter.

27. The assembly of claim 26, wherein the optical spacer comprises a plurality of reflective walls that define an optical cavity.

28. The assembly of claim 26, wherein the optical spacer comprises a monolithic transparent material.

29. The assembly of claim 26, wherein the linearly variable thin film coating is on the surface of a substrate.

30. The assembly of claim 29, further comprising a blocking filter coating over the linearly variable thin film coating.

31. A color measuring sensor assembly for a spectrometer device, the assembly comprising:
a fiber coupling means for securely receiving an optical fiber;
a filter means for selectively transmitting light received from the fiber coupling means in a linearly variable manner along a length thereof;
a light circulating means for repeatedly reflecting light received from the optical fiber onto the filter means;
a detector means for measuring the spectral characteristics of the light transmitted through the filter means, the detector means having a photosensitive surface positioned directly opposite from the filter means a predetermined distance; and
a light propagating means for transmitting light from the filter means to the detector means and projecting an upright, noninverted image of the filter means onto the photosensitive surface of the detector means.

32. The assembly of claim 31, wherein the light propagating means comprises a plurality of gradient index lenses.

33. The assembly of claim 31, wherein the light propagating means comprises a plurality of microlenses.

34. The assembly of claim 31, wherein the light propagating means comprises a coherent fiber plate.

35. A color measuring sensor assembly for a spectrometer device, the assembly comprising:
a fiber receiving block having a fiber ferrule configured to receive an optical fiber;
an optical spacer;
a reflective coating adjacent to the optical spacer;
a linear variable filter for selectively transmitting light in a predetermined range of wavelengths along a length thereof;
a linear detector array having a photosensitive surface positioned directly opposite from the linear variable filter a predetermined distance; and
a light beam propagating means for transmitting light from the filter to the detector array and projecting an upright, noninverted image of the filter onto the photosensitive surface of the detector array.

36. The assembly of claim 35, wherein the optical spacer comprises a plurality of reflective surfaces that define an optical cavity.

37. The assembly of claim 35, wherein the optical spacer comprises a block that is optically transparent over a predetermined wavelength range.

38. The assembly of claim 35, wherein the optical spacer comprises a monolithic transparent material.

39. A method of fully illuminating a linear variable filter, comprising:
directing a beam of light into an optical spacer, the optical spacer having a first side and a second side, the first side having a reflective coating adjacent thereto and the second side adjacent to a linear variable filter;
repeatedly reflecting light that is incident upon a portion of the linear variable filter that is not in a preselected passband for that portion of the linear variable filter; and
repeatedly reflecting light that is incident upon the reflective coating towards the linear variable filter.
